(19) United States
(12) Patent Application Publication
(10) Pub. No.: US 2009/0250295 A1
(43) Pub. Date: Oct. 8, 2009

(54) Portable Elevated Platform

(76) Inventor: David J. Laws, Provo, UT (US)

Correspondence Address: THORPE NORTH & WESTERN, LLP., P.O. Box 1219, SANDY, UT, 84091-1219, US

(21) Appl. No.: 12/098,945

(22) Filed: Apr. 7, 2008

(51) Int. Cl. E04G 1/18; B23P 11/00

(52) U.S. Cl. 182/223; 29/428

(57) ABSTRACT

A portable elevated platform includes a plurality of decks positionable adjacent one another in a flat configuration. Each deck includes an upper flat surface, and a plurality of contiguous sides extending around a perimeter of each deck. Each side includes an insert extending outward from the side and adjacent a corner of the side, and a receptacle extending inward into the side and adjacent an opposite corner from the insert. Each side of each deck is positioned adjacent any side of any other of the plurality of decks with at least one contiguous corner of each deck aligned such that the inserts and receptacles of the adjacently positioned sides mate together.

### RELATED APPLICATIONS

This application is related to U.S. patent application Ser. No. ______, filed Apr. 7, 2008, entitled “Portable Elevated Platform with Locking Legs” as TNW docket no. 000538-32685, and U.S. patent application Ser. No. ______, filed on Apr. 7, 2008, entitled “Telescoping Leg Lock and Portable Elevated Platform with Same” as TNW docket no. 000538-32687, which are herein incorporated by reference in their entirety for all purposes.

### BACKGROUND OF THE INVENTION

1. Field of the Invention

The present invention relates generally to portable elevated platforms such as stages, risers, scaffolding, and the like.

2. Related Art

Many portable elevated platforms such as portable stages, risers, scaffolding and the like are assembled from a plurality of smaller platforms or decks. Such platforms are pushed together to form a larger platform and usually have an interlocking feature that aligns the platforms. These interlocking features can also help to keep the platforms together. For example, some platforms use C-clamps or leg locks to pull together individual decks and keep them together. As another example, some platforms have dowels or pins in one side and corresponding holes in another side. When the platforms are pushed together, the dowels or pins of one platform fit into the holes of another platform. The dowels and holes both align the platforms, and also help to restrict vertical movement of the platforms with respect to one another.

Some platforms, such as indicated at 500 in FIG. 10, use a tongue and groove system for joining the individual smaller platforms 510 together to form the larger platform 500. These systems have a tongue or protrusion 520 along one side and a groove or slot 530 along the other. The protrusion of one platform can fit into the slot of another adjacently placed platform. In this way, the smaller platforms 510 can be joined together 500.

Unfortunately, platforms having such interlocking features must be positioned in a particular orientation in order to push the platforms together. For example, as shown in FIG. 10, the side 522 with the tongue or protrusion 520 in one platform 510 must be positioned adjacent the side 532 with the groove or slot 530 in another platform 510 in order for the tongue to be pushed into the groove. If two tongues are oriented toward one another, then the platforms will not be joinable. Similarly, if two grooves are oriented toward one another, the platforms will not be joinable together. Thus, in order to assemble the larger platform 500, the individual smaller platforms 510 must be laid out and oriented with respect to one another prior to being pushed together.

### SUMMARY OF THE INVENTION

The inventors of the present invention have recognized that it would be advantageous to develop a portable elevated platform assembled from a plurality of smaller platforms having a universal interlocking system that will interlock the smaller platforms regardless of lateral or rotational orientation of the smaller platforms with respect to one another. Additionally, the inventors of the present invention have recognized that it would be advantageous to develop a method and device for interconnecting a plurality of decks to form a larger elevated platform.

The invention provides for a portable elevated platform including a plurality of decks positionable adjacent one another in a flat configuration. Each deck can include an upper flat surface, and a plurality of contiguous sides extending around a perimeter of each deck. Each side can include an insert extending outward from the side and adjacent a corner of the side, and a receptacle extending inward into the side and adjacent an opposite corner from the insert. The receptacle can be oriented transverse to an insert on a contiguous side of the deck. Each side of each deck can be positioned adjacent any side of any other of the plurality of decks with at least one contiguous corner of each deck aligned such that the inserts and receptacles of the adjacently positioned sides mate together.

The present invention also provides for a method for assembling an elevated platform including orienting a side of a deck with any side of another deck. Each deck can have an insert extending outward from the side and adjacent a corner, and a receptacle extending inward into the side and adjacent an opposite corner from the insert. The receptacle can be oriented adjacent to a transverse insert extending outward from a contiguous side of the deck. At least one corner of the oriented sides of the decks can be aligned to position the inserts and the receptacles in a mating orientation. The oriented sides of each deck can be pushed together to form the elevated platform.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a portable elevated platform in accordance with an embodiment of the present invention;

FIG. 2 is a top view of the platform of FIG. 1;

FIG. 3 is a perspective fragmentary view of a corner of the portable elevated platform of FIG. 1;

FIG. 4 is a cross section view a pair of joined corners of the platform of FIG. 1;

FIG. 5 is a top view of a portable elevated platform in accordance with another embodiment of the present invention;

FIG. 6 is a top view of a deck of a portable elevated platform in accordance with another embodiment of the present invention;

FIG. 7 is a top view of a portable elevated platform assembled from a plurality of the decks shown in FIG. 4;

FIG. 8 is a top view of a deck of a portable elevated platform in accordance with another embodiment of the present invention;

FIG. 9 is a top view of a portable elevated platform assembled from a plurality of the decks shown in FIG. 6; and

FIG. 10 is a perspective view of a prior art modular platform.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein provide generally for a portable elevated platform such as a portable stage, riser, scaffolding and the like. The portable elevated platform can include a plurality of decks that can be positioned side by side one another to form a flat platform. Each deck can have a plurality of contiguous sides that form a perimeter around each deck. The perimeter can have corners where the contiguous sides are joined together. Each contiguous side can include an insert, such as a tongue, and a receptacle, such as a groove. The insert can extend outward from the side and can be positioned on the side adjacent a corner of the perimeter. The receptacle can extend inward into the side and can be positioned on the side adjacent an opposite corner from the insert. Thus, each side of each deck can be positioned adjacent any similar sized side of any other deck such that the inserts and receptacles of the adjacently positioned sides can be mated together to form the platform. In this way, the decks can be rotationally symmetrical such that a given side-to-side rotational orientation is not required in order to align and assemble a plurality of decks to form the portable elevated platform. Thus, the decks can be rotated 90, 180, and 270 degrees and still fit together.

Additionally, an insert and a receptacle can be positioned adjacent one another with the insert on one side of the corner and the receptacle on a different adjoining side of the corner. In this way, the corner can include the insert and the receptacle, and the insert can be oriented transverse to the receptacle.

Advantageously, the insert and receptacle system of the embodiments of the platform described herein can automatically align the various individual decks with little effort. For example, the pushing the insert of one deck into the receptacle of an adjacent deck can align the two decks vertically so that the top surface is relatively planar between the two decks. Additionally, the insert and receptacle can laterally position each of the two decks so that other decks can be joined to the assembled platform without difficult shifting of the individual decks within the assembled platform.

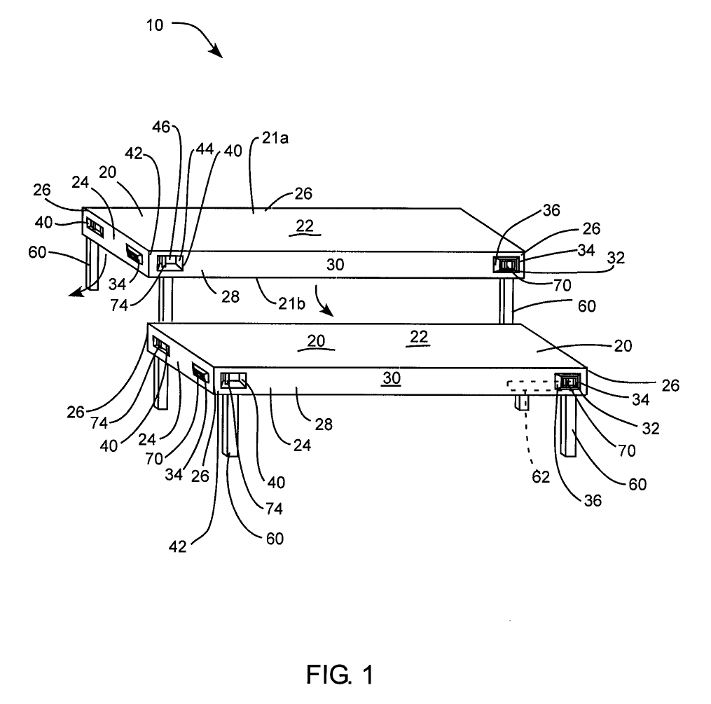

As illustrated in FIGS. 1-4, a portable elevated platform, indicated generally at 10, in accordance an embodiment of the present invention shown for use as a portable stage, riser, scaffold, and the like. The portable elevated platform 10 can include a plurality of decks 20, positioned adjacent one another in a generally flat configuration, as shown in FIG. 1. Each of the decks 20 can include a generally flat upper surface 22, a plurality of contiguous sides 24 joined together at corners 26 to form a perimeter 28 around the deck 20, and a plurality of collapsible legs 60.

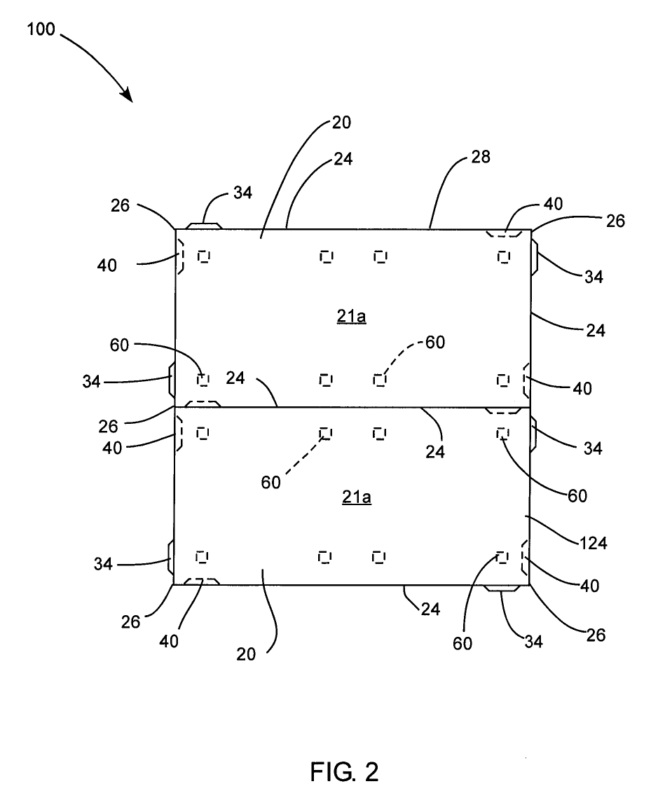

The upper flat surface 22 can be integrally formed with the sides 24 and corners 26, as shown in FIGS. 1-2. In one aspect, the upper surface 22 and plurality of contiguous sides 24 of each of the decks 20 can be integrally formed together in a molding process such as a rotational molding process, an injection molding process, a blow molding process, and extrusion process, a casting process, a compression molding process, and the like. Additionally, the platform components can be formed by a combination of these fabrication processes, as known in the art. Moreover, the upper flat surface 22 can have structural members (not shown) that can provide sufficient strength to the upper surface to support and carry an applied load. The deck 20 can be formed with side rails 24 extending between corner members 26 and supporting a deck thereon. In another embodiment, the corner 26 can be formed of cast aluminum with extruded aluminum sides and a laminate wood deck as described below.

Each deck 20 can also include opposing flat surfaces or sides 21a and 21b. The deck 20 can be selectively turned over or reversible such that either of the opposing flat surfaces 21a and 21b can be positioned as the upper flat surface 22. It will be appreciated that each of the opposing flat surfaces 21a and 21b can have different physical properties such as tread, stiffness, texture, material, and the like. For example, on one side, the opposing flat surface 21a can include a soft rubber material, and on the opposing side, the flat surface 21b can include a carpet. In this way, each deck 20 can be reversed to accommodate the purposes of the assembled elevated platform 10.

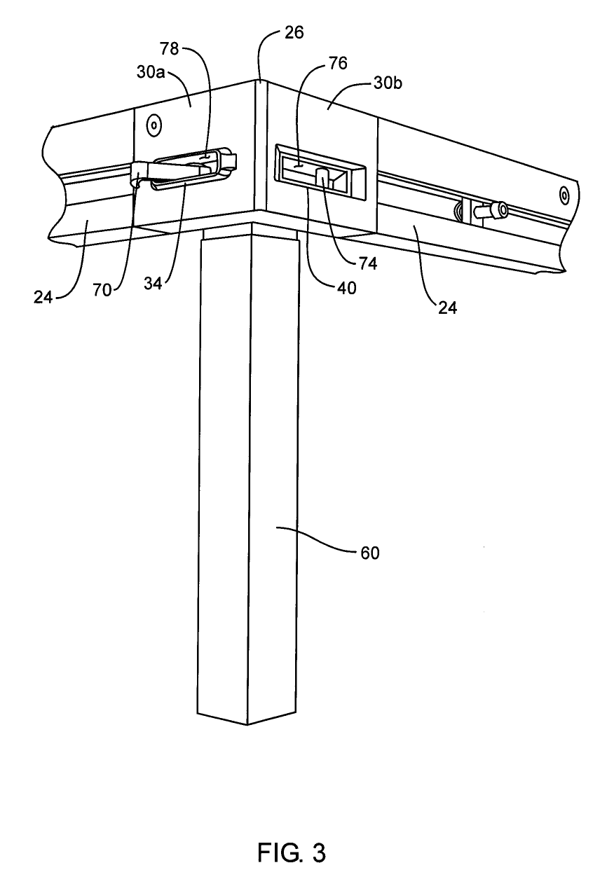

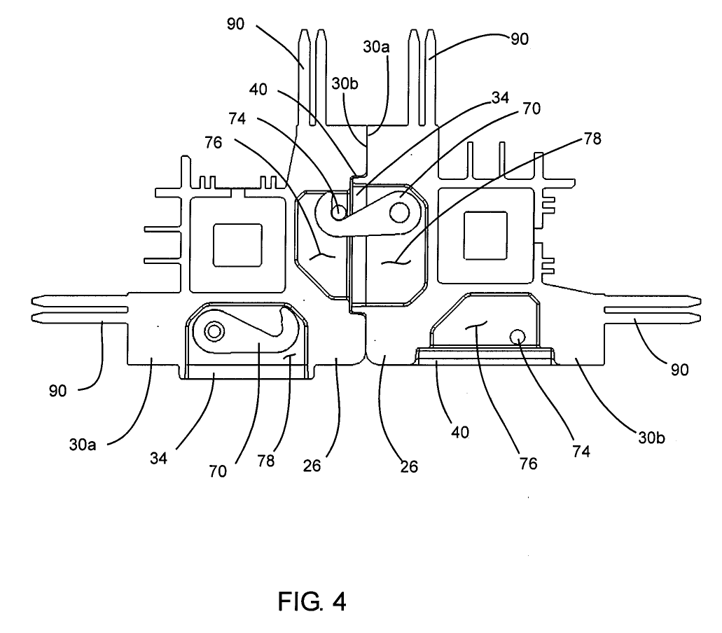

The sides of each deck 24 can be joined together at ends to form corners 26, as shown in FIGS. 3-4. In this way, the sides 24 can be contiguous and can form a perimeter 28 extending around the deck 20. The sides 24 can also have a face 30 that can be oriented substantially perpendicular to the upper flat surface 22. The face 30 of each contiguous side 24 can be oriented at an oblique angle with respect to the faces of the sides joined to each end 32 of the side 24 at the corners 26. Additionally, the sides 24 can include a receptacle or receptacles 40, and a mating insert or inserts 34.

The mating insert 34 of each side 24 can extend outward from the side, and can be positioned on the corner 26 adjacent an end 32 of the side. The insert 34 can be integrally formed with the corner 26. Additionally, the corner 26 and the side 24 can be formed as separate or discrete components and joined together to form the perimeter 28. In one aspect, the insert 34 can have tapering or narrowing walls 36 such that a cross section of the insert is larger near the side 24 and smaller farther away from the side 24.

The receptacles 40 of each side 24 can extend inward into the side, and can be positioned on the side adjacent an opposite end 42 of the side from the end 32 the insert 34 is on. In this way, the receptacle 40 can be positioned near a corner 26. The receptacle 40 can be integrally formed with the deck 20 and can have widening walls 44 such that a cross section of the receptacle 40 is narrower at a base 46 of the receptacle 40 and wider near the side 24.

It will be appreciated that the narrowing walls 36 of the insert 34 can be sized, shaped and oriented to mate with, and engage the widening walls 44 of the receptacle 40. In this way, when the decks 20 are pushed together to form the platform 10, the receptacles 40 can receive the inserts 34 and the narrowing walls 36 of the insert 34 can engage the widening walls 44 of the receptacle 40. Advantageously, the tapering or narrowing of the walls of the insert and the tapering or widening of the walls of the receptacle can guide and lock the sides of the platform into a precise horizontal and vertical alignment with respect to one another. In this way, the insert 34 can be sized and shaped to fit within the receptacle 40 of an adjacent deck and can vertically and laterally align adjacently positioned decks during the process of mating two adjacent decks.

It will also be appreciated that with the insert 34 on one end 32 of the side 24 and the receptacle 40 on the other end 42 of the side 24, an insert 34 and a receptacle 40 can be associated with each corner 26. Specifically, each corner 26 can have an insert 34 extending outward on one side and a receptacle 40 extending inward on the adjoining side. In this way, the insert 34 and receptacle 40 associate with each corner 26 can be oriented transverse to one another and at oblique angles with respect to each other.

Additionally, this insert and receptacle corner configuration, advantageously, defines a universal intercoupling system between each deck 20. Thus, it is a particular advantage of the portable elevated platform 10 described herein, that each side 24 of each deck 20 can be positioned adjacent any side 24 of any other of the plurality of decks 20 with at least one corner 26 of each deck aligned with each other such that the inserts 34 and receptacles 40 of the adjacently positioned sides 24 can mate together. In this way, particular side-to-side orientation of the decks with respect to adjacently positioned decks is not required.

Referring again to FIGS. 3-4, each corner 26 can also have a hook 70 and a latch 74. In one aspect, the hook 70 can be pivotally coupled to the deck 20 and positioned inside the insert 34. The hook 70 can pivot away from the side 24 of the deck, and out of the extended insert 34. Additionally, the insert 34 can be hollow and have a space or aperture 78 through which the hook 70 can pivot.

Additionally, each deck 20 can have a latch 74 disposed in the deck 20 inside a space 76 in the receptacle 40. The latch 74 can be a pin latch and can include a pin, dowel, bolt, screw, rod and the like. The latch 74 can be fastened to the deck inside the receptacle.

It will be appreciated that the hook 70 and the latch 74 can be disposed inside either the insert or the receptacle. Thus, while FIGS. 1-4 show the hook 70 disposed inside the insert 34 and the latch 74 disposed inside the receptacle 40, the hook may also be disposed inside the receptacle and the latch disposed inside the insert.

The hook 70 can pivot out of the insert 34 to engage the latch 74 inside the receptacle 40 of an adjacent deck 20 in order to pull the insert 34 and receptacle 40 together. In this way, the hook 70 can secure the decks 20 together in a closely abutting relationship.

Advantageously, with the hook 70 and the latch 74 disposed inside the insert 34 and the receptacle 40, respectively, the likelihood of interference or snagging of nearby objects by the hook or latch is reduced. Additionally, since the hook 70 and the latch 74 do not extend below or above the flat surfaces of the deck, the individual decks 20 can easily be stacked on top of one another for shipping and storage without interference from the hook or latch.

The hook 70 can pivot or swing between an extended position and a stowed position. In the stowed position, the hook 70 can be pivoted into the insert 34. In the extended position the hook 70 can be pivoted outward away from the side of the 24 of the deck. Additionally, in the extended position, the hook 70 can extend into a receptacle of an adjacent platform and hook onto the latch 74 in the receptacle. In this way, when the hook engages the latch, the hook can draw the adjacent platform toward the insert until the insert 34 is drawn into the receptacle 40. In this way the hook 70 and latch 74 can secure the insert 34 in the receptacle 40 and hold adjacently placed decks 20 together in close proximity or an abutting relation to one another.

The corners 26 can also have side attachment flanges 90. The side attachment flanges 90 can extend away from the corners 26 in the direction of the sides 24 and can attach to sides 24 that form the perimeter 28 of the deck 20. The sides 24 can join the corners 26 together and the corners can couple the sides together such that the sides are contiguous around the perimeter 28 of the deck 20.

The corners 26 can also have two intersecting side surfaces 30a and 30b. The two intersecting side surfaces 30a and 30b can be oriented at an oblique angle with respect to one another. It will be appreciated that the oblique angle can be determined based on the number of sides each deck has. Thus, as shown in FIGS. 1-4, the oblique angle can be approximately 90 degrees and the deck 20 can have four sides.

Each deck 20 of the elevated platform can also have a plurality of legs 60 pivotally coupled to a lower surface of each of the plurality of decks 20. The legs 60 can be pivoted between a stowed position, indicated by dashed lines at 62 in FIG. 1, and an extended position. The legs 60, in the extended position, can elevate the platform 10. Such pivoting legs 60 are further described in U.S. patent application Ser. No. ______, filed on ______ as TNW Docket No. 00538-32685, which is incorporated by reference herein in its entirety for all purposes.

Additionally, the height of each leg 60 can be adjustable to allow positioning each of the plurality of decks to a predetermined elevation. Thus, each leg 60 can have a locking mechanism (not shown), that can secure the leg 60 at a predetermined height. Such height adjustable legs 60 are further described in U.S. patent application Ser. No. ______, filed on ______ as TNW Docket No. 00538-32687, which is incorporated by reference herein in its entirety for all purposes.

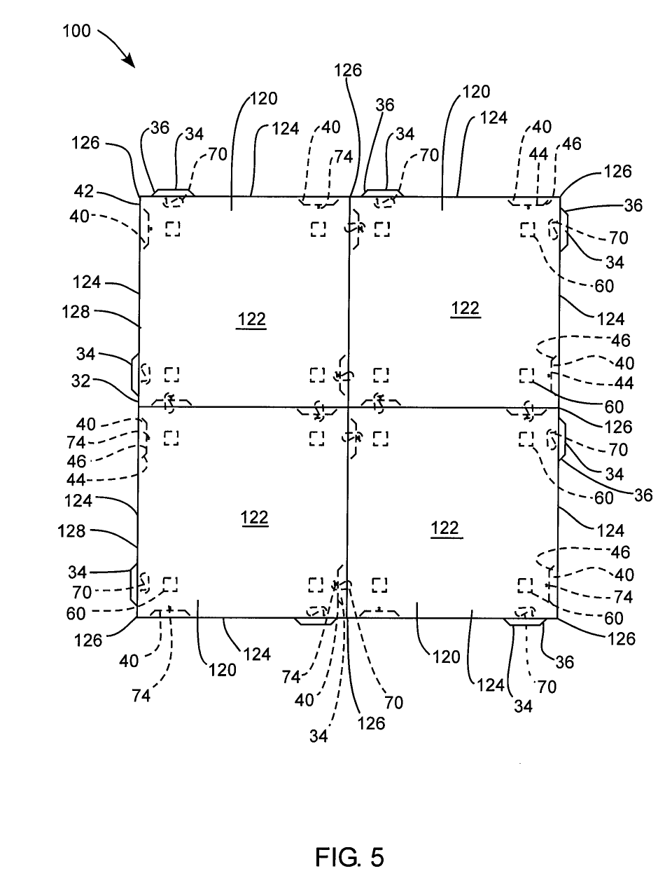

Each deck 20 can be substantially quadrangular, as shown in FIGS. 1-5. Specifically, the plurality of contiguous sides 24 can include four sides such that each deck 20 has a quadrangular shape such as a rectangle, as shown in FIGS. 1-2, or a square, as shown in FIG. 5. Thus, in one aspect, each side 24 of the deck 20 can be oriented orthogonally with respect to adjoining contiguous sides.

As illustrated in FIG. 5, square shaped decks, indicated generally at 120 are shown in accordance with another embodiment of the present invention for use in forming a portable elevated platform 100. The rectangular shaped decks 120 can be similar in many respects to the plurality of decks 20 described above and shown in FIGS. 1-4. The square shaped decks 120 can have a generally flat upper surface 122, a plurality of sides 124 joined together at corners 126 to form a perimeter 128 around the deck 120, and a plurality of collapsible legs 60. The square shaped decks 120 can also have receptacles or receptacles 40, and mating inserts or inserts 34 positioned inside each corner 126, as described above.

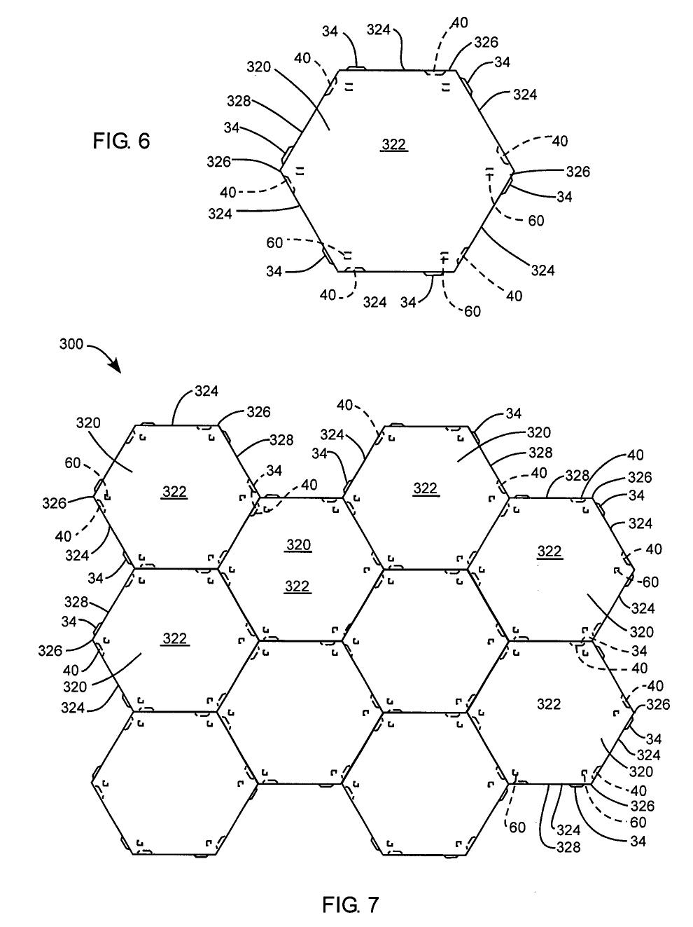

As illustrated in FIGS. 6-7, hexagonal shaped decks, indicated generally at 320 are shown in accordance with another embodiment of the present invention for use in forming a portable elevated platform 300. The hexagonal shaped decks 320 can be similar in many respects to the plurality of decks 20, 120 and 220 described above and shown in FIGS. 1-5. The hexagonal shaped decks 320 can have a generally flat upper surface 322, a plurality of sides 324 joined together at corners 326 to form a perimeter 328 around the deck 320, and a plurality of collapsible legs 60. The hexagonal shaped decks 320 can also have receptacles or receptacles 40, and mating inserts or inserts 34 positioned adjacent each corner 326, as described above.

It will be appreciated that the portable elevated raised platforms described herein can include a plurality of decks having any number of sides greater than three sides. In one aspect, each deck can have between 3 and 8 contiguous sides with each side oriented at an oblique angle with respect to adjoining contiguous sides. For example, each deck may have four sides as shown in FIGS. 1-5. Additionally, each deck may have five sides with a pentagonal shape (not shown). Further more, each deck may have six sides with a hexagonal shape, as shown in FIGS. 6-7. Decks with 7, 8 or more sides (not shown) are also contemplated by the principles of the present invention, as are arcuate and curved sides.

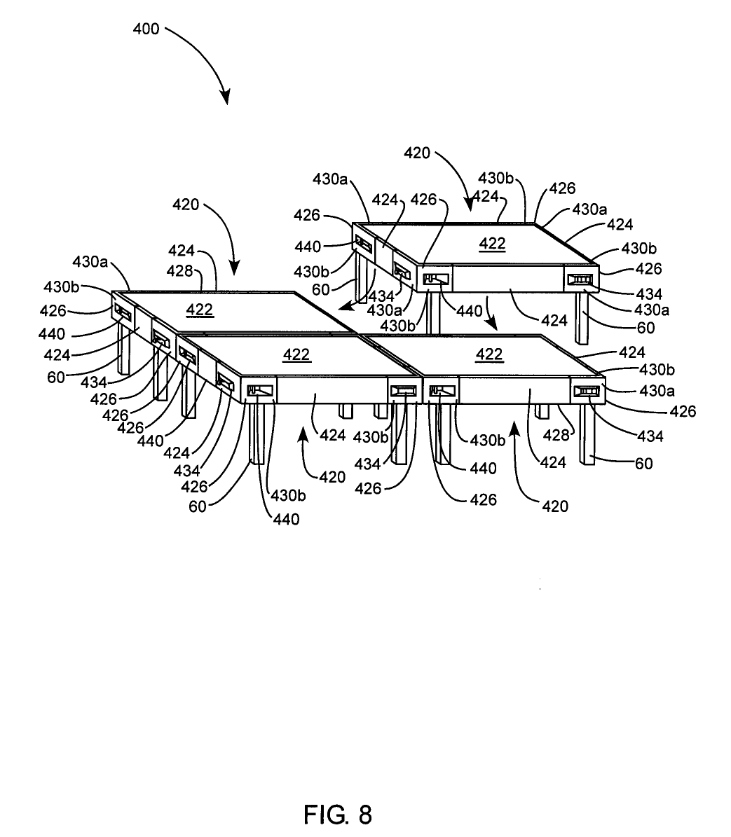

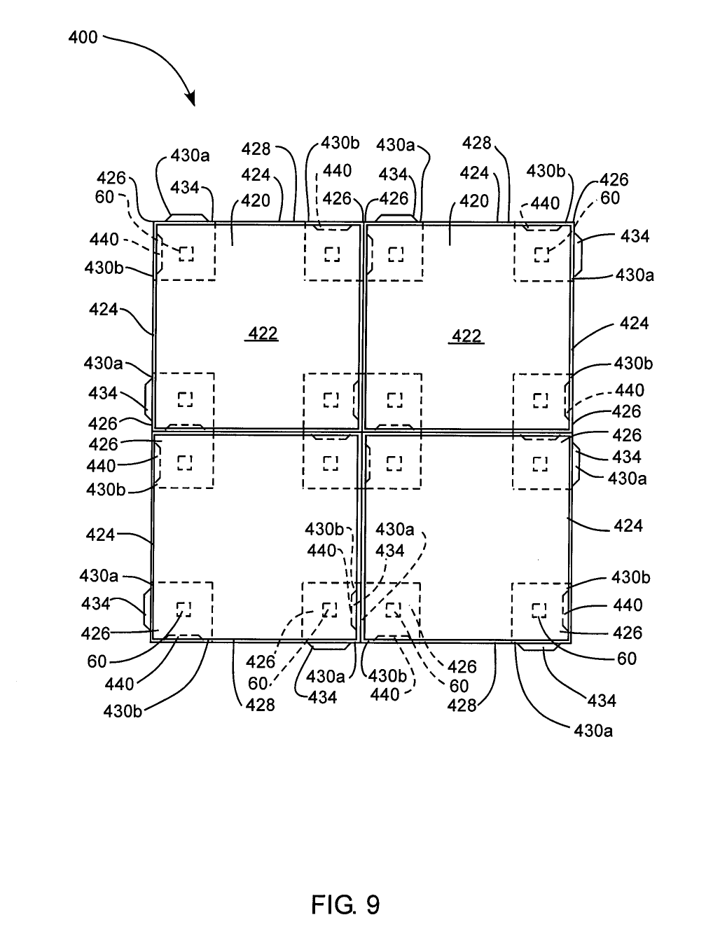

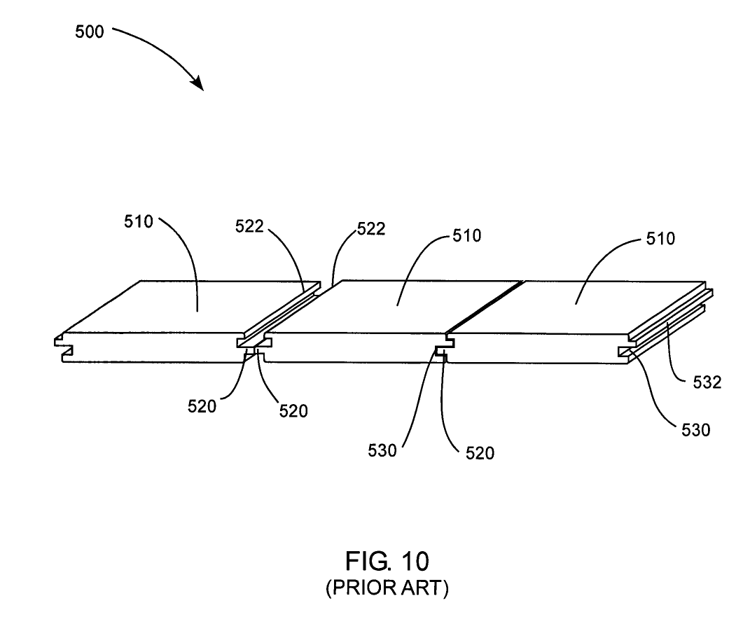

As illustrated in FIGS. 8-9, a portable elevated platform, indicated generally at 400, in accordance another embodiment of the present invention shown for use as a portable stage, riser, scaffold, and the like. The portable elevated platform 400 can be similar in many respects to the portable elevated platform 10 and 100 described above and shown in FIGS. 1-5. The portable elevated platform 400 can include a plurality of decks, indicated generally at 420, positioned adjacent one another in a generally flat configuration. Each of the decks 420 can include a generally flat upper surface 422, a plurality of sides 424 joined together at corners 426 to form a perimeter 428 around the deck 420, and a plurality of collapsible legs 60.

Additionally, the platform 400, corners 426, and sides 424 can be formed individually and as separate and discrete components that can be joined together by an assembly process to form each deck 420. For example, the corner 426 can be cast aluminum, and the sides can be extruded aluminum. The sides 424 can be joined to the corners to form the perimeter 428.

The upper surface 422 can be a substantially flat sheet and can be formed of any suitably strong material. For example, the upper surface 422 can be formed of a sheet of laminate wood, such as plywood, or the like, which can be placed on top of the assembled sides 424 and corners 426.

The corners 426 can include two intersecting side surfaces 430a and 430b. The two intersecting side surfaces 430a and 430b can be oriented at an oblique angle with respect to one another. It will be appreciated that the oblique angle can be determined based on the number of sides each deck has. Thus, as shown in FIGS. 8-9, the oblique angle can be approximately 90 degrees and the deck 420 can have four sides.

Each corner 426 can also have an insert 434 and a receptacle 440. The insert 434 can be disposed on one of the intersecting side surfaces 430a and the receptacle 440 can be disposed in the other of the intersecting side surfaces 430b. In this way, the insert 434 and the receptacle 440 can be oriented in a transverse or oblique orientation with respect to each other.

A pivotal leg 60 can also be pivotally coupled to each of the corners 426. In this way, each deck 420 can have a plurality of pivotal legs 60 that can support and carry the deck.

Thus, in summary, the embodiments of the portable platforms described herein provide several advantages over other types of portable platforms and decking. For example, the inserts and receptacles of the individual decks can precisely and automatically align the various individual decks without additional leveling by the assembler. Specifically, pushing the insert of one deck into the receptacle of an adjacent deck can automatically align the two decks vertical position such that the top surface of each deck is relatively co-planar with the other adjacently joined decks. Additionally, the insert and receptacle can laterally position each of the adjacent decks together so that other decks can be joined to the assembled platform without difficult rotational or lateral shifting of the individual decks within the assembled platform. Moreover, the hook and post engagement mechanism along with the insert and receptacle can reduce horizontal and vertical relative motion between each deck. Furthermore, the positioning of the insert and receptacles on the deck sidewalls provide for rotational symmetry of the individual decks such that any side of any deck can mate with any other side of any other deck, and the decks need not be aligned or positioned in any particular angular or rotational orientation with respect to one another. All of these features and advantages of the portable platform of the present invention work to make the assembled platform easier to assemble and more stable under dynamic and static load conditions than other portable platforms.

The present invention also provides for a method for assembling an elevated platform including orienting a side of a deck with any side of another deck. Each deck can have an insert extending outward from the side and adjacent a corner, and a receptacle extending inward into the side and adjacent an opposite corner from the insert. The receptacle can be oriented adjacent to a transverse insert extending outward from a contiguous side of the deck. At least one corner of the oriented sides of the decks can be aligned to position the inserts and the receptacles in a mating orientation. The oriented sides of each deck can be pushed together to form the elevated platform.

The method can also include pivoting a hook pivotally coupled to one of the decks adjacent the insert to engage a latch coupled to the other of the decks adjacent the receptacle. The hook can pull the insert and receptacle together so as to secure the decks together.

The method can also include pivoting a leg coupled to lower surface of each of the plurality of decks into an extended position. The leg can be placed on a support surface to support the platform in an elevated position.

Additionally, the hook can be pivoted away from the latch and the decks can be pulled apart to disengage the insert and the receptacle.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A portable elevated platform, comprising:
a) a plurality of decks positionable adjacent one another in substantially horizontal configuration, each deck comprising:
i) an upper surface;
ii) a plurality of contiguous sides extending around a perimeter of each deck, each side further comprising:
1) an insert extending outward from the side and adjacent a corner of the side; and
2) a receptacle extending inward into the side and adjacent an opposite corner from the insert, and transverse to an insert on a contiguous side of the deck; and
b) each side of each deck being positionable adjacent any side of any other of the plurality of decks with at least one contiguous corner such that the inserts and receptacles of the adjacently positioned sides mate together.

2. A platform in accordance with claim 1, wherein the insert has straight narrowing walls extending out from the side and the receptacle has straight widening walls extending out of the side, the straight narrowing walls of the insert being engageable with the straight widening walls of a corresponding receptacle.

3. A platform in accordance with claim 1, wherein the insert is sized and shaped to fit within the receptacle of an adjacent deck and to vertically and laterally align adjacently positioned decks.

4. A platform in accordance with claim 1, further comprising a plurality of legs pivotally coupled to a lower surface of each of the plurality of decks and pivotal between a stowed position and an extended position with the legs elevating the platform in the extended position.

5. A platform in accordance with claim 4, wherein the height of each leg is adjustable to allow positioning each of the plurality of decks to a predetermined elevation.

6. A platform in accordance with claim 1, wherein each deck in the plurality of decks further comprising:
a) a hook pivotally coupled to the deck inside the insert, and pivotal to extend out of the insert;
b) a latch disposed in the deck inside the receptacle; and
c) the hook being pivotal to engage the latch of an adjacent deck to pull the insert and receptacle together so as to secure the decks together.

7. A platform in accordance with claim 1, wherein the upper surface and plurality of contiguous sides of an individual deck are integrally formed together in a molding process selected from the group consisting of rotational molding, injection molding, blow molding, extrusion, casting, and combinations thereof.

8. A platform in accordance with claim 1, wherein the plurality of contiguous sides includes 4 sides and each deck has a quadrangular shape with each side oriented orthogonally with respect to adjoining contiguous sides.

9. A platform in accordance with claim 1, wherein each of the plurality of decks further includes opposite flat surfaces, each opposite flat surface being selectively positionable as the upper flat surface.

10. A portable elevated platform, comprising:
a) a plurality of decks positionable adjacent one another in a substantially flat configuration, each deck comprising:
i) an upper surface;
ii) a plurality of sides extending around a perimeter of each deck; and
iii) a plurality of corners joining the sides together in series to form the perimeter, each corner further comprising:
1) a pair of sides joined together to form the corner with each side oriented transverse to the other;
2) an insert extending outward from one of the sides; and
3) a receptacle extending inward into the other of the pair of sides; and
b) each side of each deck being positionable adjacent any side of any other of the plurality of decks with at least one contiguous corner such that the inserts and receptacles of the adjacently positioned sides mate together.

11. A platform in accordance with claim 10, wherein the insert has straight narrowing walls and the receptacle has straight widening walls, the straight narrowing walls of the insert being engageable with the straight widening walls of a corresponding receptacle.

12. A platform in accordance with claim 10, further comprising a plurality of legs pivotally coupled to a lower surface of each of the plurality of decks, the legs being pivotal between a stowed position and an extended position with the legs elevating the platform in the extended position.

13. A platform in accordance with claim 12, wherein the height of each leg is adjustable to allow positioning each of the plurality of decks to a predetermined elevation.

14. A platform in accordance with claim 10, each deck in the plurality of decks further comprising:
a) a hook pivotally coupled to the deck inside the insert, and pivotal to extend out of the insert;
b) a latch disposed in the deck inside the receptacle; and
c) the hook being pivotal to engage the latch of an adjacent deck to join the insert and receptacle together so as to secure the decks together.

15. A platform in accordance with claim 10, wherein the corners are formed in a molding process selected from the group consisting of rotational molding, injection molding, blow molding, extrusion, casting, and combinations thereof.

16. A platform in accordance with claim 10, wherein the plurality of sides includes 4 sides and each deck has a quadrangular shape with each corner orienting each side orthogonally with respect to adjoining contiguous sides.

17. A platform in accordance with claim 10, wherein the plurality of contiguous sides includes between 3 and 8 sides with each side oriented at an oblique angle with respect to adjoining contiguous sides.

18. A method for assembling an elevated platform, comprising:
a) orienting a side of a deck with any side of another deck, each side of each deck having:
i) an insert extending outward from the side and adjacent a corner; and
ii) a receptacle extending inward into the side and adjacent an opposite corner from the insert and adjacent to a transverse insert extending outward from a contiguous side of the deck;
b) aligning at least one corner of the oriented sides of the decks to position the inserts and the receptacles in a mating orientation; and
c) pushing the oriented sides of each deck together to form the elevated platform.

19. A method in accordance with claim 18 further comprising:
a) pivoting a hook pivotally coupled to one of the decks inside the insert to engage a latch coupled to the other of the decks inside the receptacle to join the insert and receptacle together so as to secure the decks together.

20. A method in accordance with claim 18, further comprising:
a) pivoting a leg coupled to lower surface of each of the plurality of decks into an extended position; and
b) placing the leg on a support surface to support the platform in an elevated position.
